(19) United States
(12) Patent Application Publication
(10) Pub. No.: US 2006/0280159 A1
(43) Pub. Date: Dec. 14, 2006

(54) Method and apparatus for voice communication

(76) Inventors: Hao Bi, Wheeling, IL (US); Ron Rotstein, Arlington Heights, IL (US); John M. Harris, Chicago, IL (US); Fan Wang, Vernon Hills, IL (US); Jiangnan J. Chen, Hawthorn Woods, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/149,802

(22) Filed: Jun. 10, 2005

(51) Int. Cl. H04B 7/216

(52) U.S. Cl. 370/342

(57) ABSTRACT

The present invention is a method and apparatus for voice communication. Vocoded frames are transmitted using a transmission intervals. Each transmission interval is split into a first interval portion and a second interval portion. Code symbols associated with each vocoded frame are divided into a group A and a group B. The method includes transmitting group A code symbols of a first vocoded frame using a first interval portion of an interval i; decoding the group A code symbols received at the first interval portion of the interval i; performing an error detection code check on the first interval portion of the interval i; generating and sending a negative acknowledgment signal when the first interval portion of the interval i fails the error detection code check; and transmitting group B code symbols of the first vocoded frame using a second interval portion of an interval i+N.

### FIELD OF THE INVENTION

The present invention relates generally to the field of communications and more particularly to a method and apparatus for optimizing voice communications within a communication system using automatic retransmissions.

### BACKGROUND

Communication systems, such as the commonly known code division multiple access (CDMA) 2000 which is the next generation of the commonly known system based on Interim Standard-95 (IS-95) CDMA standard, or wide-band CDMA (W-CDMA) which is the next generation of the commonly known system based on the global system for mobile communication (GSM) standards, and other such mobile communications systems suffer from a degradation of capacity due to the fading nature of the radio frequency (RF) link. As a mobile device moves in a fading environment, the signal strength vanes and channel capacity is decreased. Improvements to the overall capacity of a communication system can be obtained by improved fading mitigation schemes. Further, voice capacity improvements are essential to the growth of such systems.

There are typically two limiting factors to voice capacity in a CDMA system, one is the RF capacity and the other one is the Walsh code space. (Also known as “Walsh-Hadamard code,” Walsh code is an algorithm that generates statistically unique sets of numbers for use in encryption and cellular communications.) To a certain degree, a tradeoff can be made between these two depending on a system load. For example, there are two radio configurations, RC3 and RC4, for the forward link of a CDMA2000 system. A voice call in RC4 consumes half of the Walsh code space than in RC3, but requires a signal-to-noise ratio (SNR) of approximately 1.15 dB higher than in RC3 for the same frame erasure ratio (FER) under certain channel conditions. With the development of a Selectable Mode Vocoder (SMV), RF efficiency can be further balanced with voice quality or voice activity. SMV contains a set of modes with different mixes of full rate, half rate, quarter rate, and eighth rate frames. The voice quality and RF load generated by a SMV mode depend on the percentages of each type of frame.

The higher the percentage of full rate frames is, the better the voice quality is, but the higher the generated RF load is. There is a half-rate maximum mode, where the highest rate a voice frame can have is half-rate. This was originally designed for scenarios when a network gets congested. It has been found that its quality is satisfactory for push-to-talk applications.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram depiction of a communication system in accordance with an embodiment of the present invention.

FIG. 2 is a block diagram depiction of a base station for operation within the communication system of FIG. 1 in accordance with an embodiment of the present invention.

FIG. 3 is a block diagram depiction of a communication device for operation within the communication system of FIG. 1 in accordance with an embodiment of the present invention.

FIG. 4 illustrates an example of a voice communication in accordance with an embodiment of the present invention.

FIGS. 5-7 are logic flow diagrams of steps executed in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

This invention includes a new transmission method and apparatus for voice vocoder frames by introducing hybrid automatic retransmission requests (H-ARQ) for voice communication services. This invention further provides a new transmission method and apparatus for Enhanced Variable Rate Codec (EVRC) frames, SMV frames, and other voice vocoders' frames, which takes advantage of the RF benefits of H-ARQ.

Before describing in detail embodiments that are in accordance with the present invention, it should be observed that the embodiments reside primarily in combinations of method steps and apparatus components related to a method and apparatus for voice communication. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a method and apparatus for voice communication described herein. The non-processor circuits may include, but are not limited to, a radio receiver, a radio transmitter, signal drivers, clock circuits, power source circuits, and user input devices. As such, these functions may be interpreted as steps of a method to perform voice communication. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

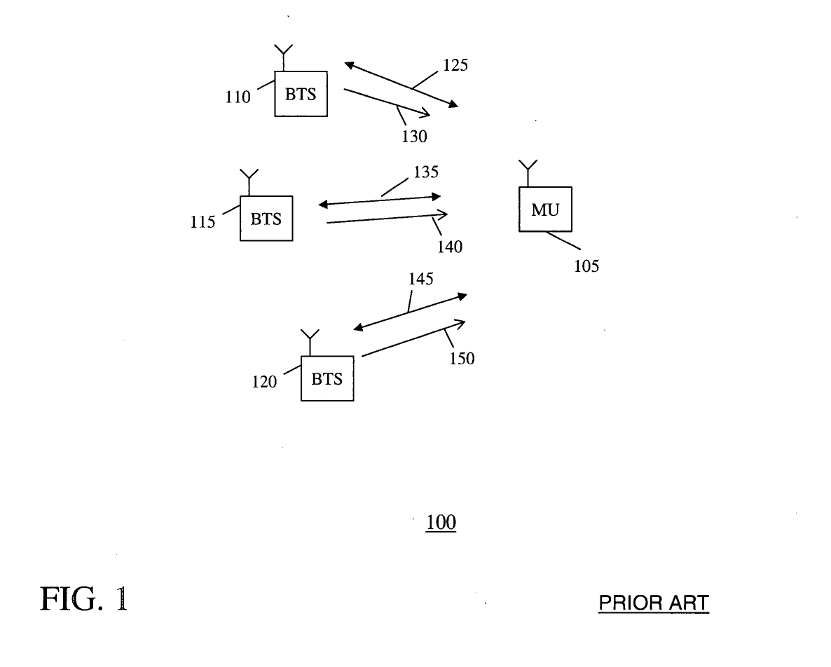

FIG. 1 is a block diagram of communication system 100 in accordance with one embodiment of the present invention. The communication system 100, for example, utilizes a next generation CDMA architecture as described in the CDMA2000 International Telecommunication Union-Radio communication (ITU-R) Radio Transmission Technology (RTT) Candidate Submission document, but in alternate embodiments the communication system 100 may utilize other analog or digital cellular communication system protocols such as, but not limited to, the next generation Global System for Mobile Communications (GSM) protocol, or the CDMA system protocol as described in “Personal Station-Base Station Compatibility Requirements for 1.8 to 2.0 GHz Code Division Multiple Access (CDMA) Personal Communication Systems” (American National Standards Institute (ANSI) J-STD-008).

Communication system 100 includes multiple Base Transceiver Stations (BTS) such as 110,115,120, and at least one mobile units (MUs) 105. Each of the BTS 110, 115, 120 communicate with the at least one mobile unit 105 by transmitting one or more vocoded frames 130, 140, 150 using a plurality of transmission intervals, wherein each of the plurality of transmission intervals is split into a first interval portion and a second interval portion, and further wherein a plurality of code symbols associated with each vocoded frame are divided into a group A and a group B.

The mobile unit 105, for example, can be a mobile cellular telephone, a mobile radio data terminal, a mobile cellular telephone having an attached or integrated data terminal, a two-way messaging device, or an equivalent. Similarly, the mobile unit 105 can be any other electronic device such as a personal digital assistant or a laptop computer having wireless communication capabilities.

The Base Transceiver Stations 110,115,120, and the at least one mobile units 105 communicate using at least one traffic channel 125, 135, 145. For example, the base transceiver stations 110, 115, 120 use the traffic channel 125, 135, 145 for communicating the group A code symbols and the group B code symbols to the mobile unit 105. In one embodiment, the traffic channel includes at least one sub-channel for communicating from the mobile unit 105 to the base transceiver stations 110, 115, 120. The sub-channel, for example, can comprise a control information sub-channel of the traffic channel. The sub-channel can be used to send such signals as acknowledgement signals when communications are successful received by the mobile unit 105 and alternatively negative acknowledgement signals when communications are not successfully received by the mobile unit 105. In one embodiment, the one or more of the traffic channels 125, 135, 145 includes at least one sub-channel for communicating from the base transceiver stations 110, 115, 120 to the mobile unit 105. The sub-channel, for example, can comprise a control information sub-channel of the traffic channel 125, 135, 145. The sub-channel can be used to carry one or more retransmission flags in soft handoff scenarios.

Although not shown, communication system 100 additionally include well known network elements such as Mobile Switching Centers (MSCs), Centralized Base Station Controllers (CBSCs) in a circuit switch network, or such as Radio Network Controller (RNCs), Gatekeepers (GKs) and GateWays (GWs) in a packet switch network. It is contemplated that network elements within the communication system 100 are configured in well known manners with processors, memories, instruction sets, and the like, which function in any suitable manner to perform the function set forth herein.

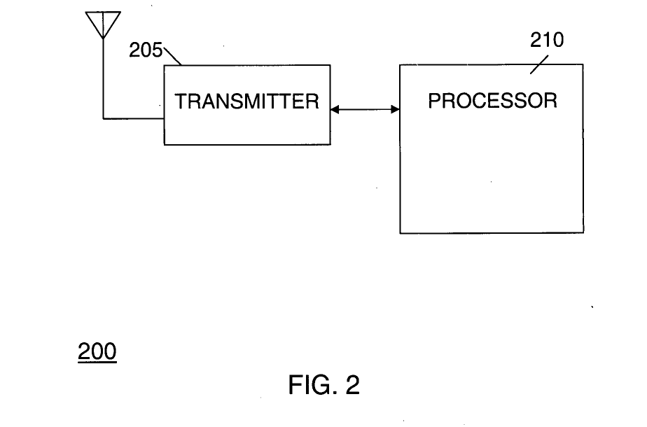

FIG. 2 illustrates a base station 200 for operation within the communication system 100 of FIG. 1. The base station 200 for example, can be one of the base transceiver stations 110, 115, and 120 of FIG. 1.

The base station 200 includes a transmitter 205 for communicating with one or more communication devices such as the mobile unit 105 of the communication system 100. The base station 200 further includes a processor 210 coupled to the transmitter 205 for processing voice communications such one or more vocoded frames. The processor 210, in accordance with the present invention, is adapted to cause the transmitter 205 to transmit a group A code symbols of a vocoded frame using a first interval portion of an interval i to one or more devices such as the mobile unit 105 of FIG. 1. The processor 210 is further adapted to cause the transmitter 205 to transmit a group B code symbols of the vocoded frame using a second interval portion of an interval i+N, wherein N is a positive integer, in response to receiving a negative acknowledgement signal from the mobile unit 105.

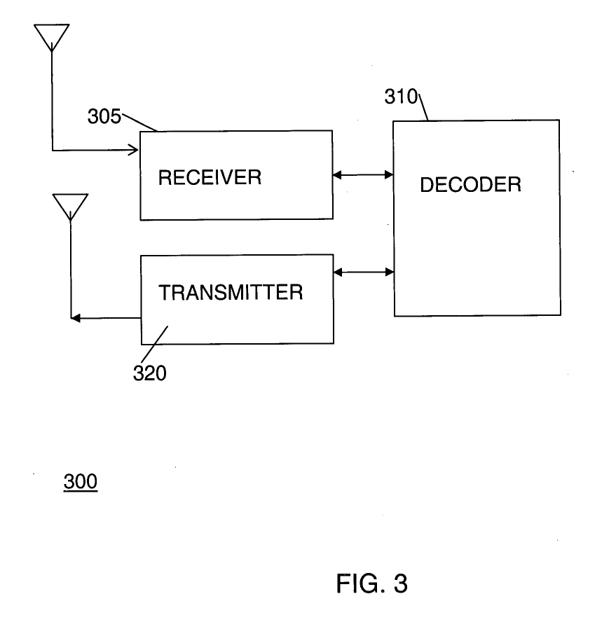

FIG. 3 illustrates a communication device 300 for operation within the communication system 100 of FIG. 1. The communication device 300, for example, can be the mobile unit 105 of FIG. 1. The communication device 300 includes a receiver 305, a transmitter 320, and a decoder 310 coupled to the receiver 305 and the transmitter 320. The communication device 300 further includes components such as memory, programming, and other microprocessor devices as is well known in the art. In one embodiment of the present invention, a known CDMA 2000 communication device is adapted using known telecommunications design and development techniques to implement the logic of the present invention.

The receiver 305, for example, receives the group A code symbols of the vocoded frame from the base station 200 in FIG. 2. The communication device 300 further includes a decoder 310 coupled to the receiver 305. The decoder 310 is adapted to process communications passed to it by the receiver 305. For example, the decoder 310 is adapted to decode the group A code symbols received at the first interval portion of the interval i, and perform a cyclic redundancy code check, or any general error detection on the first interval portion of the interval i; generate a negative acknowledgment (NAK) signal when the first interval portion of the interval i fails the cyclic redundancy code check, or other equivalent error detection check; and cause a device transmitter 320, which is coupled to the decoder 310, to send the NAK signal to the base station 200. In one embodiment of the present invention, the decoder 310 is further adapted to combine group A and group B code symbols of the vocoded frame before the decoding; and generate a frame erasure for the vocoded frame when the combined A and B code symbols of the vocoded frame fail the cyclic redundancy check, or other equivalent error detection scheme.

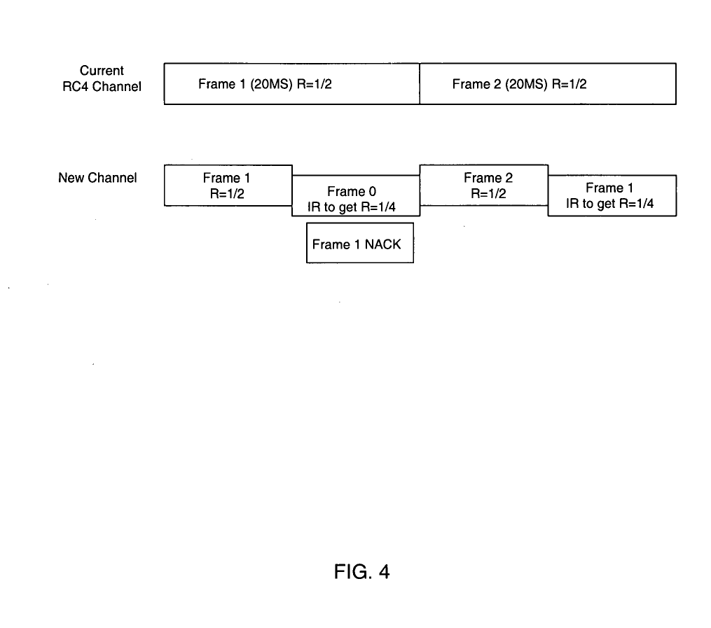

FIG. 4 illustrates a voice transmission using the concept of transmitting a voice frame with H-ARQ. In this example, a voice frame is channel coded using a 1/4 convolution code. Other error correction codes can also be used. The code symbols are divided into two groups, group A and group B. A 20 ms transmission interval is split into two parts each of 10 ms. For the ith transmission interval, the first half is used to transmit the group A code symbols of frame i, and the second half is reserved for potential retransmission of frame i−1 with its group B code symbols. After decoding group A code symbols of frame i, if the frame fails CRC (cyclic redundancy code) check, a NAK signal is generated and sent back to the transmitter. The group B of code symbols of frame i are then transmitted in the second half of transmission interval i+1. A H-ARQ with IR (incremental redundancy) combining can be performed with both group A and group B code symbols of frame i. After decoding combined group A and group B code symbols, if frame i still fails the CRC check, a frame erasure will be generated.

ACK/NAK information can be carried by the control sub-channel. For a mobile unit in soft/softer handoff, special care needs to be taken for ACK/NAK and retransmission. For the reverse link transmission (ACK/NAK from base station), the mobile unit does retransmission only if a NAK is received from all soft/softer legs. For forward link transmission (ACK/NAK from mobile station), the retransmission on individual soft/softer legs is performed if a NAK is received by that leg. Due to the detection reliability, especially when there is significant unbalance among soft/softer legs, not all soft/softer legs can receive NAK signaling correctly. That is, retransmission may happen only on a subset of soft/softer legs because some of the soft/softer legs do not detect the NAK sent by mobile unit correctly. Since the mobile unit has no knowledge of whether a base station receives the NAK or not, it hence does not know if a retransmission happens on a soft/softer leg. This causes a problem within the mobile unit when it tries to do combining on signals from soft/softer legs: on one hand it loses RF efficiency if it doesn't combine a leg when there is retransmission; on the other hand it hurts receiver performance by taking in noise if it combines a leg when there is no retransmission. It also prevents the mobile unit's receiver to correctly scale the soft code symbols from the retransmission for channel decoding. In accordance with the present invention, the concept is to transmit a flag on the control sub-channel to indicate if a retransmission for frame i−1 is present at the second half of transmission interval i.

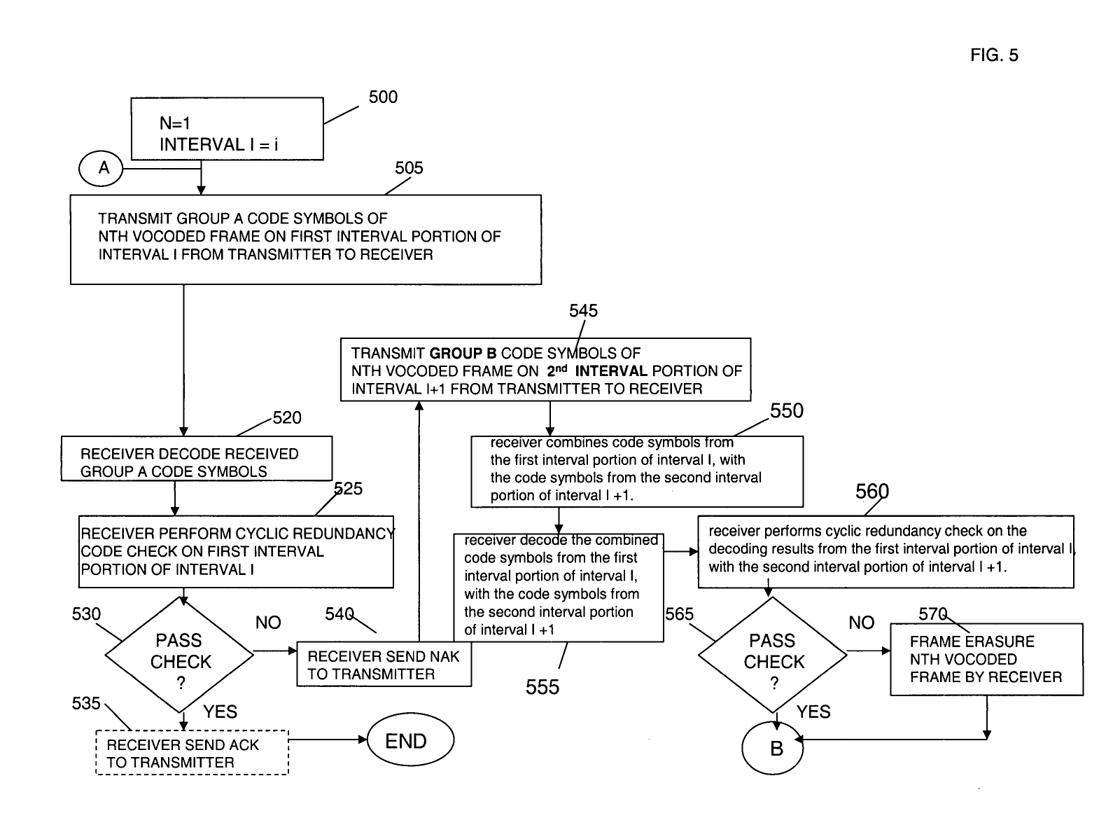

FIGS. 5-7 are logic flow diagrams of steps executed in accordance with an embodiment of the present invention.

Referring to FIG. 5, a flowchart of a voice communication method in accordance with one embodiment of the present invention is illustrated. The voice communication method as illustrated in FIG. 5 presumes one or more vocoded frames are transmitted using a plurality of transmission intervals. In one embodiment, each of the plurality of transmission intervals of the voice communication are channel coded using a 1/x error correction code, where x is an integer. Each of the plurality of transmission intervals is split into a first interval portion and a second interval portion. In one embodiment, each of the plurality of transmission intervals comprise a twenty (20) millisecond transmission interval, and further wherein the first frame portion and the second frame portion each comprise a ten (10) millisecond frame. Further, a plurality of code symbols associated with each vocoded frame are divided into a group A and a group B.

As shown, the operation begins with Step 500 in which a parameter N is set to 1 and an interval I is set to i. Next, in Step 505, a group A code symbols of a Nth vocoded frame is transmitted from a transmitter to a receiver using a first interval portion of an interval I. For example, the transmitter can transmit the group A code symbols to the receiver using a traffic channel of the communication system.

Next, the operation continues to Step 520 in which the receiver decodes the group A code symbols received at the first interval portion of the interval I. Next, in Step 525, the receiver performs a cyclic redundancy code check on the first interval portion of the interval I. Next, in Step 530, the receiver determines whether or not the first interval portion of the interval I passed or failed the cyclic redundancy code check. When the first interval portion of the interval I passed the cyclic redundancy code check, the operation can optionally proceed with Step 535 in which the receiver generates and sends an acknowledgment (ACK) signal to the transmitter. The operation then ends.

When the first interval portion of the interval I fails the cyclic redundancy code check in Step 530, the operation continues with Step 540 in which the receiver generates and sends a negative acknowledgment (NAK) signal to the transmitter. For example, the receiver can send the negative acknowledgment (NAK) signal to the transmitter using a sub-channel of the traffic channel of the communication system. The sub-channel, for example, can be a control information sub-channel of the traffic channel.

Next, in Step 545, the transmitter transmits to the receiver group B code symbols of the Nth vocoded frame using a second interval portion of an interval I+1. It will be appreciated that the interval can alternatively be any I+m, where m is a positive integer. It will be further appreciated that the transmitter can transmit the group B code symbols to the receiver using a traffic channel of the communication system. The operation then continues to node B.

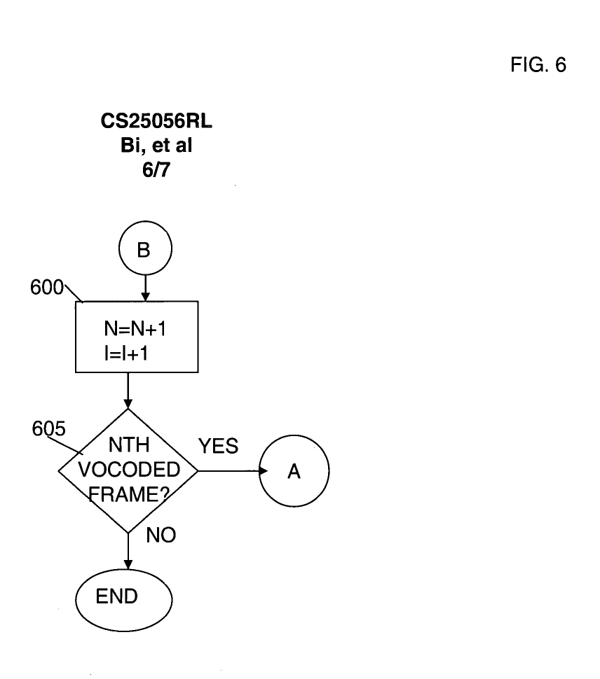

Next, in Step 550, receiver combines code symbols from the first interval portion of interval I, with the code symbols from the second interval portion of interval I+1. For example, the combining can comprise performing a hybrid automatic retransmission request (H-ARQ) with incremental redundancy (IR) on the group A code symbols in the first interval portion of interval I with the group B codes symbols in the second interval portion of the interval I+1. Next, in Step 555, the receiver decodes the combined code symbols from the first interval portion of interval I, with the code symbols from the second interval portion of interval I+1. Next, in Step 560, the receiver performs cyclic redundancy check on the decoding results from both the code symbols of the first interval portion of interval I and the code symbols from the second interval portion of interval I+1. Next, in Step 565, the receiver determines whether or not the cyclic redundancy code check succeeds. When the cyclic redundancy code check passes, the operation continues to node B of FIG. 6. When the cyclic redundancy code check fails, the operation continues with Step 570 in which the receiver generates a frame erasure for the Nth vocoded frame. The operation then continues to node B of FIG. 6.

Referring to FIG. 6, a flowchart of further operation of a voice communication method in accordance with one embodiment of the present invention is illustrated. As illustrated, the operation of FIG. 6 begins with node B. Next, in Step 600, the parameter N is incremented by 1 and the interval I is set to I+1. Next, in Step 605, the operation determines whether or not there is a Nth vocoded frame. When there is an Nth vocoded frame, the operation returns to Node A and performs the operations of FIG. 5 on the Nth vocoded frame. When no Nth vocoded frame is present, the operation ends.

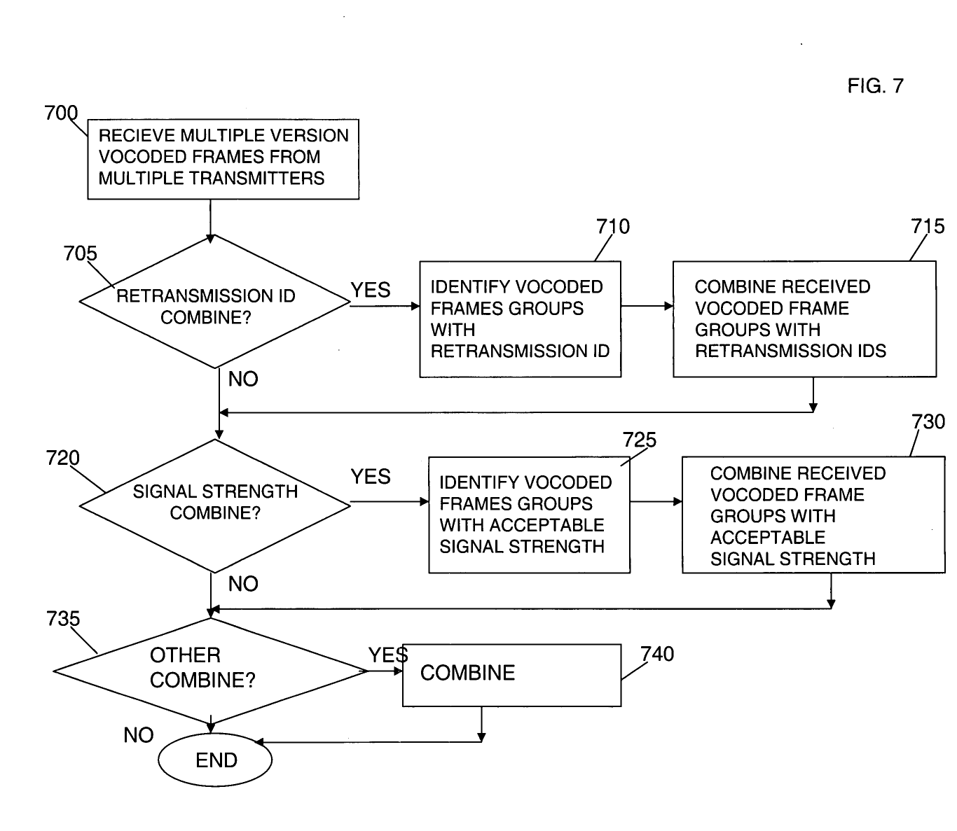

Referring to FIG. 7, a flowchart of further operation of a voice communication method in accordance with one embodiment of the present invention is illustrated. As illustrated, the operation of FIG. 7, the operation begins with Step 700 in which multiple version vocoded frames are transmitted from multiple transmitters to a receiver. For example, one or more vocoded frames are transmitted by the two or more transmitters using a plurality of transmission intervals. In accordance with the present invention, each of the plurality of transmission intervals is split into a first interval portion and a second interval portion, and further wherein a plurality of code symbols associated with each vocoded frame are divided into a group A and a group B. Next, in Step 705, the operation determines whether or not a combining using retransmission identifications of the received multiple versions of the vocoded frame is activated. For example, Each transmitter, in response to receiving a NAK from the receiver, can transmit a retransmission identification code to the receiver along with the group B code symbols of the vocoded frame to facilitate recreating a quality voice transmission. When a retransmission identification combine is activated in Step 705, the operation continues to Step 710 in which the receiver identifies which received transmissions include the retransmission identification code. Next, in Step 715, the receiver combines group A code symbols with group B code symbols of the vocoded frame using the received transmissions having the retransmission identification code.

Next, and when retransmission identification combining was not active in Step 705, the operation continues to Step 720 in which it is determined whether or not signal strength combining is activated. When signal strength combining is active, the operation continues to Step 725 in which the signal strength of each of the received transmissions is measured; and those with signal strength values greater than a predetermined signal strength are identified. Next, in Step 730, the receiver combines group A and group B code symbols of the vocoded frame using the received transmissions with signal strength values greater than a predetermined value.

Next, and when the signal strength combining is not active in Step 720, the operation continues to Step 735 to determine if any other combining method is active. When another combining method is activated, the operation continues to Step 740 and that combining is accomplished. Next, and when no other combining method is active, the operation ends.

The present invention, as described herein, provides a novel transmission method and apparatus for voice vocoder frames by introducing H-ARQ for voice service thereby improving radio frequency efficiency. The H-ARQ operation is introduced for voice service with the same high Walsh code efficiency as existing systems. Maximal ratio combining is enabled for soft/softer handoff without complexity of blind detection of retransmission on individual soft/softer leg. The present invention thus provides a novel method and apparatus to increase voice capacity in voice communication systems.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A voice communication method within a communication system, wherein one or more vocoded frames are transmitted using a plurality of transmission intervals, wherein each of the plurality of transmission intervals is split into a first interval portion and a second interval portion, and further wherein a plurality of code symbols associated with each vocoded frame are divided into a group A and a group B, the method comprising the steps of:
transmitting from a transmitter to a receiver group A code symbols of a first vocoded frame using a first interval portion of an interval i;
decoding at the receiver the group A code symbols received at the first interval portion of the interval i;
performing an error detection code check on the first interval portion of the interval i;
generating and sending a negative acknowledgment (NAK) signal from the receiver to the transmitter when the first interval portion of the interval i fails the error detection code check; and
transmitting from the transmitter to the receiver group B code symbols of the first vocoded frame using a second interval portion of an interval i+N, wherein N comprises a positive integer.

2. The voice communication method of claim 1 further comprising the steps of:
combining group A and group B code symbols of the first vocoded frame before the decoding step; and
generating a frame erasure for the first vocoded frame when the combined A and B code symbols of the first vocoded frame fail the error detection code check.

3. The voice communication method of claim 2, wherein the combining step comprises:
performing a hybrid automatic retransmission request (H-ARQ) with incremental redundancy (IR) on the group A and group B codes symbols of the first vocoded frame.

4. The voice communication method of claim 1, further comprising the steps of:
transmitting from a transmitter to a receiver group A code symbols of a second vocoded frame using a first interval portion of an interval i−M, wherein M comprises a positive integer;
decoding at the receiver the group A code symbols received at the first interval portion of the of the interval i−M;
performing an error detection code check on the first interval portion of the interval i−M;
generating and sending a negative acknowledgment (NAK) signal from the receiver to the transmitter when the first interval portion of the interval i−M fails the error detection code check; and
transmitting from the transmitter to the receiver group B code symbols of the second vocoded frame using a second interval portion of the interval i.

5. The voice communication method of claim 4 further comprising the steps of:
combining group A and group B code symbols of the second vocoded frame before the decoding step; and
generating a frame erasure for the second vocoded frame when the combined A and B code symbols of the second vocoded frame fail the error detection code check.

6. The voice communication method of claim 5, wherein the second combining step comprises:
performing a hybrid automatic retransmission request (H-ARQ) with incremental redundancy (IR) on the group A and group B codes symbols of the second vocoded frame.

7. The voice communication method of claim 1, wherein the communication system includes a traffic channel,
wherein the transmitter transmits the group A code symbols and the group B code symbols using the traffic channel,
and further wherein the negative acknowledgment (NAK) signal is sent from the receiver to the transmitter using a sub-channel of the traffic channel.

8. The voice communication method of claim 7, wherein the sub-channel is a control information sub-channel of the traffic channel.

9. The voice communication method of claim 1, wherein each of the plurality of transmission intervals of the voice communication are channel coded using a 1/x error correction code, where x is an integer.

10. The voice communication method of claim 1, wherein each of the plurality of transmission intervals comprise a twenty (20) millisecond transmission interval, and further wherein the first frame portion and the second frame portion each comprise a ten (10) millisecond frame.

11. The voice communication method of claim 1, further comprising the step of:
generating and sending an acknowledgment (ACK) signal from the receiver to the transmitter when the first interval portion of the interval i passes the error detection code check.

12. A communication system comprising:
at least one transmitter device including:
a transmitter for transmitting one or more vocoded frames using a plurality of transmission intervals, wherein each of the plurality of transmission intervals is split into a first interval portion and a second interval portion, and further wherein a plurality of code symbols associated with each vocoded frame are divided into a group A and a group B, the transmitter adapted to:
transmit a group A code symbols of a vocoded frame using a first interval portion of an interval i; and
at least one receiver device including:
a receiver for receiving the group A code symbols of the vocoded frame from the transmitter device;
a decoder adapted to:
decode the group A code symbols received at the first interval portion of the interval i, and
perform a error detection code check on the first interval portion of the interval i; and
a device transmitter for generating and sending a negative acknowledgment (NAK) signal to the at least one transmitter device when the first interval portion of the interval i fails the error detection code check,
wherein the at least one transmitter device is further adapted to:
transmit a group B code symbols of the vocoded frame using a second interval portion of an interval i+N, wherein N is a positive integer, in response to receiving the negative acknowledgement signal.

13. The communication system of claim 12, wherein the decoder of the receiver device is further adapted to:
combine group A and group B code symbols of the vocoded frame before the decoding; and
generate a frame erasure for the vocoded frame when the combined A and B code symbols of the vocoded frame fail the error detection check.

14. The communication system of claim 12, further comprising:
a traffic channel for communicating the group A code symbols and the group B code symbols from the transmitter device to the receiver device, the traffic channel including:
a sub-channel for communicating the negative acknowledgment (NAK) signal from the receiver device to the transmitter device.

15. The communication system of claim 14, wherein the sub-channel comprises a control information sub-channel of the traffic channel.

16. The communication system of claim 12, wherein each of the plurality of transmission intervals of the voice communication are channel coded using a 1/x error correction code, where x is an integer.

17. The communication system of claim 12, wherein each of the plurality of transmission intervals comprise a twenty (20) millisecond transmission interval, and further wherein the first frame portion and the second frame portion each comprise a ten (10) millisecond frame.

18. A voice communication method within a communication system for transmitting a voice communication from two or more transmitters to a receiver, wherein one or more vocoded frames are transmitted by the two or more transmitters using a plurality of transmission intervals, wherein each of the plurality of transmission intervals is split into a first interval portion and a second interval portion, and further wherein a plurality of code symbols associated with each vocoded frame are divided into a group A and a group B, the method comprising the steps of:
transmitting from each of the two or more transmitters a group A code symbols of a vocoded frame using a first interval portion of an interval i;
for each of the received transmissions from each of the two or more transmitters at the receiver:
decoding at the communication device the group A code symbols of the vocoded frame of the interval i;
performing an error detection code check on the first interval portion of the interval i;
generating and sending a negative acknowledgment (NAK) signal from the communication device to the transmitter when the first interval portion of the interval i fails the error detection code check; and
transmitting from each transmitter to the receiver group B code symbols of the vocoded frame using a second interval portion of an interval i+N, wherein N comprises a positive integer, and transmitting to the receiver with group B code symbols of the vocoded frame a retransmission identification code.

19. The voice communication method of claim 18 further comprising at the receiver prior to the decoding step, the steps of:
identifying which received transmissions include the retransmission identification code; and
combining the group A code symbols with the group B code symbols of the vocoded frame using the received transmissions including the retransmission identification code.

20. The voice communication method of claim 18 further comprising at the receiver prior to the decoding step, the steps of:
measuring the signal strength of each of the received transmissions; and
combining the group A code symbols with the group B code symbols of the vocoded frame using the received transmissions with signal strength values greater than a predetermined value.

21. The voice communication method of claim 18 further comprising at the receiver prior to the decoding step, the steps of:
identifying which received transmissions include the retransmission identification code;
combining the group A code symbols with the group B code symbols of the vocoded frame using the received transmissions including the retransmission identification code;
comparing the quality of the voice transmission resulting from the combining step with a predetermined value;
when the voice transmission quality is less than the predetermined value, measuring the signal strength of each of the received transmissions; and
combining the group A code symbols with the group B code symbols of the vocoded frame using the received transmissions with signal strength values greater than a predetermined value.

22. The voice communication method of claim 18, wherein the communication system includes a traffic channel,
wherein each of the two or more transmitters transmits the group A code symbols and the group B code symbols using the traffic channel,
and further wherein the negative acknowledgment (NAK) signal is sent from the receiver to the transmitter using a sub-channel of the traffic channel.
